(19) United States
(12) Patent Application Publication
(10) Pub. No.: US 2021/0051542 A1
(43) Pub. Date: Feb. 18, 2021

(54) FURTHER ACCESS ATTEMPTS IN CONDITIONAL HANDOVER

(71) Applicant: NOKIA TECHNOLOGIES OY, Espoo (FI)

(72) Inventors: Tommi JOKELA, Espoo (FI); Mikko SÄILY, Laukkoski (FI); Ingo VIERING, Munich (DE); Timo KOSKELA, Oulu (FI)

(21) Appl. No.: 16/967,849

(22) PCT Filed: Feb. 6, 2018
(86) PCT No.: PCT/EP2018/052955

§ 371 Date: Aug. 6, 2020

(51) Int. Cl. H04W 36/00; H04W 36/08; H04W 88/02

(52) U.S. Cl. CPC H04W 36/0079; H04W 36/0077; H04W 88/02; H04W 36/08; H04W 36/0061

(57) ABSTRACT

Various communication systems may benefit from the appropriate handling of transitioning between connections. _{For} example, certain wireless communication systems may benefit from appropriate handling of further access attempts in a conditional handover scenario. A method can include receiving, at a user equipment, an access configuration information element configured to describe a user equipment behavior during an access phase of a conditional handover. The method can also include, upon detecting a failed access to the target for which the access condition has triggered, attempting to access a candidate cell among suitable candidate cells that have been previously configured for conditional handover.

### BACKGROUND

### Field:

Various communication systems may benefit from the appropriate handling of transitioning between connections. For example, certain wireless communication systems may benefit from appropriate handling of further access attempts in a conditional handover scenario.

### Description of the Related Art

The third generation partnership project (3GPP) for new radio (NR) may support a baseline handover mechanism that is similar to the handover mechanism of long term evolution (LTE). Furthermore, a so-called conditional handover (CHO) mechanism may also need to be supported in new radio (NR). In conditional handover, the target cell is prepared in advance based on a measurement report (MR) from the user equipment (UE). The UE will access the candidate cell based on a trigger that is configured by the network, hence avoiding radio link failures due to a missed handover command

The NR baseline handover supports a mechanism whereby the failures to access a target cell, known as handover failures, are handled by triggering a re-establishment after an expiry of the timer T304. The re-establishment is successful if the UE can select a suitable cell before timer T311 expires and re-establish the connection to the selected cell before timer T301 expires.

In a typical handover, the UE may already have established a downlink synchronization with the cell to be re-established, and hence the interruption from handover failures is mainly due to the following components: T304 expiry (t304=50 . . . 10000 ms in LTE); reading of system information; re-establishment procedure (in particular contention based random access); and context fetch procedure in case the target cell was not prepared in advance.

Successful re-establishment assumes that the UE access stratum (AS) context is in the suitable cell to recover the signaling radio bearer 1 (SRB1) and security. If the AS security is not activated, the UE moves into radio resource control (RRC) idle (RRC_IDLE) state. In case of an unsuccessful re-establishment, the UE goes to idle mode and initiates a non-access stratum (NAS) recovery procedure to re-establish the connection with the network. The NAS recovery may take up to a few seconds.

### SUMMARY

According to certain embodiments, a method can include receiving, at a user equipment, an access configuration information element configured to describe a user equipment behavior during an access phase of a conditional handover. The method can also include, upon detecting a failed access to the target for which the access condition has triggered, attempting to access a candidate cell among suitable candidate cells that have been previously configured for conditional handover.

In certain embodiments, a method can include providing, to a user equipment, an access configuration information element configured to describe a user equipment behavior during an access phase of a conditional handover. The access configuration information can be configured to permit a user equipment to, upon detecting a failed access to the target for which the access condition has triggered, attempt to access a candidate cell among suitable candidate cells that have been previously configured for conditional handover.

An apparatus, according to certain embodiments, can include means for receiving, at a user equipment, an access configuration information element configured to describe a user equipment behavior during an access phase of a conditional handover. The apparatus can also include means for, upon detecting a failed access to the target for which the access condition has triggered, attempting to access a candidate cell among suitable candidate cells that have been previously configured for conditional handover.

An apparatus, in certain embodiments, can include means for providing, to a user equipment, an access configuration information element configured to describe a user equipment behavior during an access phase of a conditional handover. The access configuration information can be configured to permit a user equipment to, upon detecting a failed access to the target for which the access condition has triggered, attempt to access a candidate cell among suitable candidate cells that have been previously configured for conditional handover.

According to certain embodiments, an apparatus can include at least one processor and at least one memory including computer program code. The at least one memory and the computer program code can be configured to, with the at least one processor, cause the apparatus at least to receive, at a user equipment, an access configuration information element configured to describe a user equipment behavior during an access phase of a conditional handover. The at least one memory and the computer program code can also be configured to, with the at least one processor, cause the apparatus at least to, upon detecting a failed access to the target for which the access condition has triggered, attempt to access a candidate cell among suitable candidate cells that have been previously configured for conditional handover.

In certain embodiments, an apparatus can include at least one processor and at least one memory including computer program code. The at least one memory and the computer program code can be configured to, with the at least one processor, cause the apparatus at least to provide, to a user equipment, an access configuration information element configured to describe a user equipment behavior during an access phase of a conditional handover. The access configuration information can be configured to permit a user equipment to, upon detecting a failed access to the target for which the access condition has triggered, attempt to access a candidate cell among suitable candidate cells that have been previously configured for conditional handover.

A non-transitory computer-readable medium can, according to certain embodiments, be encoded with instructions that, when executed in hardware, perform a process. The process can include receiving, at a user equipment, an access configuration information element configured to describe a user equipment behavior during an access phase of a conditional handover. The process can also include, upon detecting a failed access to the target for which the access condition has triggered, attempting to access a candidate cell among suitable candidate cells that have been previously configured for conditional handover.

A non-transitory computer-readable medium can, in certain embodiments, be encoded with instructions that, when executed in hardware, perform a process. The process can include providing, to a user equipment, an access configuration information element configured to describe a user equipment behavior during an access phase of a conditional handover. The access configuration information can be configured to permit a user equipment to, upon detecting a failed access to the target for which the access condition has triggered, attempt to access a candidate cell among suitable candidate cells that have been previously configured for conditional handover.

According to certain embodiments, a computer program product can encode instructions for performing a process. The process can include receiving, at a user equipment, an access configuration information element configured to describe a user equipment behavior during an access phase of a conditional handover. The process can also include, upon detecting a failed access to the target for which the access condition has triggered, attempting to access a candidate cell among suitable candidate cells that have been previously configured for conditional handover.

In certain embodiments, a computer program product can encode instructions for performing a process. The process can include providing, to a user equipment, an access configuration information element configured to describe a user equipment behavior during an access phase of a conditional handover. The access configuration information can be configured to permit a user equipment to, upon detecting a failed access to the target for which the access condition has triggered, attempt to access a candidate cell among suitable candidate cells that have been previously configured for conditional handover.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a flow diagram of a method according to certain embodiments.

FIG. 3 illustrates a system according to certain embodiments.

### DETAILED DESCRIPTION

In both legacy handover (HO) and conditional handover (CHO), a target cell may not be available at the time of access. Prime reasons for such too-early handover include measurement error due to measurement filtering and signal ripple (due to noise and fast fading) and inaccurate setting of the handover parameters, for example layer three (L3) filtering, time to trigger (TTT), and A3 offset.

In a legacy handover, the UE may attempt to access the target cell until timer T304 expires. However, in many cases the target cell may not become available before T304 expires, hence triggering a re-establishment.

Similar behavior is also possible for a conditional handover. However, in CHO, prepared cells may be considered as candidates for secondary access attempts, unlike in the legacy handover.

Certain embodiments may allow a user equipment to exploit prepared candidate cells in the access phase of a conditional handover.

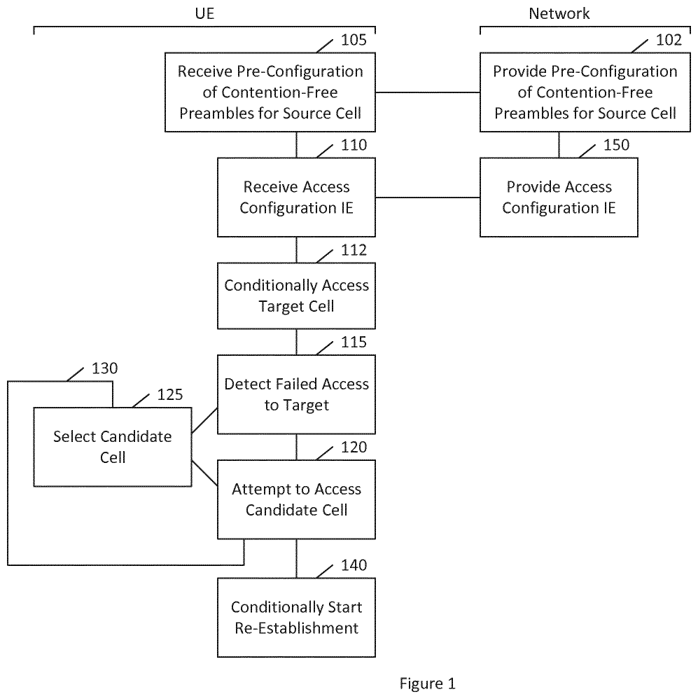

FIG. 1 illustrates a method according to certain embodiments. As shown in FIG. 1, a method can include, at 110, receiving, at a user equipment, an access configuration information element configured to describe a user equipment behavior during an access phase of a conditional handover.

Access can be attempted to a target cell at 112. The method can also include, upon detecting a failed access to the target for which the access condition has triggered at 115, attempting at 120 to access a candidate cell among suitable candidate cells that have been previously configured for conditional handover.

In certain embodiments, a source cell of the user equipment can be one of the suitable candidate cells. Thus, for example, the method can include, at 105, receiving a pre-configuration of contention free preambles for a source cell. The method can also include, at 125, selecting the candidate cell. For example, the source cell can be selected as the candidate cell. If the access of the selected candidate cell at 120 is successful, the method can end.

If access attempts to a given candidate cell are unsuccessful, the method can further include, at 130, looping back to conditionally attempt further access to another candidate cell after the attempt to access the candidate cell. Thus, in this further access a new candidate cell can be selected at 125 and an attempt can be made to access the new candidate cell at 120 The further access can be conditioned on no handover being successful yet, on no stop condition being satisfied, on time T304 not having expired, or on any combination of these.

The method can additionally include, at 140, conditionally starting a re-establishment procedure after the conditional attempt at further access. The re-establishment can be conditioned on a stop condition being satisfied, on time T304 having expired, or any combination of these.

The method can also include, at 150, providing, to a user equipment, an access configuration information element configured to describe a user equipment behavior during an access phase of a conditional handover. This can be the same access configuration information element received at 110. Thus, the access configuration information can be configured to permit a user equipment to, upon detecting a failed access to the target for which the access condition has triggered, attempt to access a candidate cell among suitable candidate cells that have been previously configured for conditional handover.

The preceding steps may be performed by a user equipment. The remainder of the method may be performed by a network element, such as a base station, evolved Node B (eNB), or next generation Node B (gNB). The method can further include, at 102, providing a pre-configuration of contention free preambles for a source cell. This can be the same pre-configuration received at 105. Thus, the pre-configuration can be configured to permit the user equipment to select the source cell as the candidate cell.

In certain embodiments, beyond the access configuration including the contention-free preambles for every target and the source, the network can also instruct the UE about how exactly to try with other pre-configured targets. For example, the network can instruct the UE as to whether the UE should try with other pre-configured targets. For another example, the network can instruct the UE when the UE is to try, such as after failed RACH, after T304 , or after a new timer. In a further example, the network can instruct the UE as to how long and/or how often the UE is to try with pre-configured targets, before re-establishment is initiated.

Accordingly, in various embodiments, a user equipment (UE) can be configured with an Access Configuration IE that describes the UE behavior during the access phase of a conditional handover. After detecting a failed random access (RA) attempt, the UE attempts to access one of the candidate cells among suitable candidate cells that have been previously configured for conditional handover.

In one further additional or alternative option the source cell may be considered as one candidate cell. Thus, the source cell may preconfigure the UE with contention free (CF) preambles in case the UE selects the source cell as a candidate after a failed RA procedure. The source cell quality may become better during the RA attempt to the original target.

The additional access attempts can be repeated until handover succeeds, a stop condition is satisfied, or T304 expires. In the latter two cases, the UE can start a re-establishment procedure.

Switching to contention based random access resources for a source cell may occur only when the user equipment does not have a conditional handover candidate that can be accessed with contention-free random access resources and the source cell is above a configured quality threshold.

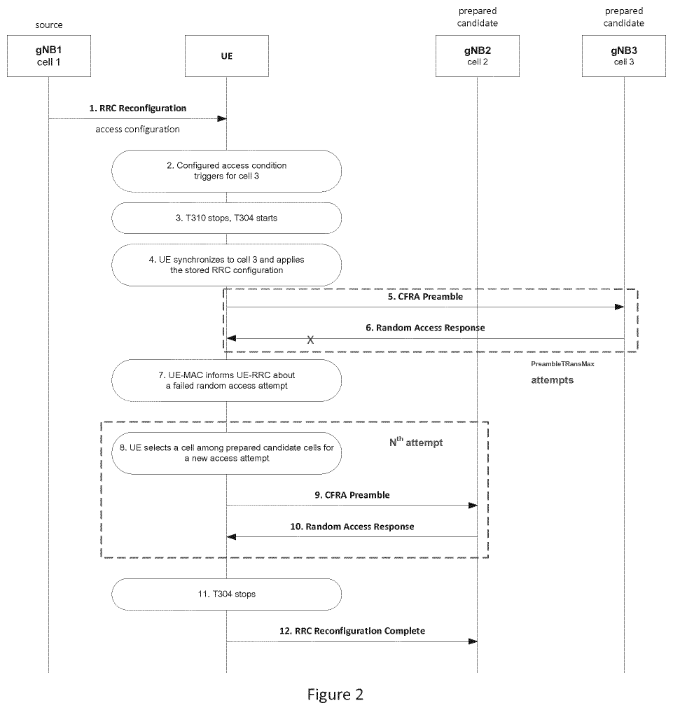

FIG. 2 illustrates a flow diagram of a method according to certain embodiments. As shown in FIG. 2, at 1 a source cell can send a radio resource control (RRC) reconfiguration message to the UE, containing an access configuration IE. The access configuration IE may contain the following elements. For example, the access configuration IE may include a validity criterion to determine whether a cell is a suitable candidate for a secondary access attempt. The validity criterion may include, for example, a condition (A1-A6), a measurement quantity (reference signal received power (RSRP), reference signal received quality (RSRQ), or signal to interference plus noise ratio (SINR)), and a reference signal type (synchronization signal block (SSB), channel state information reference signal (CSI-RS)).

The access configuration IE may also include maximum number of access attempts. This may define a maximum number of attempts that a UE can try to access valid cells before giving up. The access configuration IE may further include a periodicity of the access attempts. This possibly may include an indication of a possibility to start the next attempt right after the current attempt is finished.

Potentially, the UE may be configured with CF RA resources in the source/serving cell. This may enable the UE to have a smooth fallback to the source.

At 2, a configured CHO access condition, for example A3 or A4, for cell 3 triggers. At 3, timer T310 (a radio link failure (RLF) timer) can stop (if it was running), and timer T304 (a handover failure (HOF) timer) can start. The timer T304 for CHO may be different from the timer T304 for baseline handover, due to differences in cell access, as described at 8-10 below.

At 4, the UE can synchronize to a cell that triggered the access and can apply the RRC configuration that was stored in the UE during the handover preparation phase.

At 5, the UE can initiate a CF RA procedure and sends a contention-free random access preamble to cell 3.

At 6, cell 3 can respond with a random access response (RAR) message. Due to bad channel quality, the UE may fail to receive the RAR message within the configured time window and after PreambleTransMax attempts. This may also include the attempts using CBRA based on CF/CB resource switching rules in 3GPP TS 38.321. In this example case UE does not detect any other SSB/CSI-RS that it can indicate using CBRA resource and PreambleTransMax is hit with CFRA.

As a further option, in case of CHO, the UE may be limited to K attempts using the CF resources and in case there is no RAR response, the UE would consider the RA procedure failed.

Furthermore, in one alternative the UE may not switch to CBRA resources for the cell it currently tries to access if the UE has a CHO candidate that can be accessed with CFRA resources and the cell, or one of the SSB/CSI-RS with CFRA resources, is above the configured quality threshold.

As one further option, a new timer (T1) may be configured. This timer T1 can limit the time during which the UE attempts to connect to the currently selected cell. When the timer T1 expires and UE has not received an RAR response, or alternatively has not been able to complete HO, the UE can switch to another candidate cell.

At 7, the UE-MAC can inform UE-RRC about a failed random access attempt, such as a failed access to the target for which the access condition has triggered. At 8, the UE-RRC can select a cell among valid cells for a secondary random access attempt, following the rules provided in the access configuration IE. Valid cells can include, for example, CHO configured targets and the source cell.

At 9, the UE can send a CFRA preamble to the selected candidate cell. At 10, the selected cell can respond with a random access response. Steps 8 and 9 can be repeated until either (a) random access succeeds, (b) the maximum number of access attempts is reached, or (c) T304 expires.

The exact bases for selecting a cell for the next access attempt, among valid cells, may be left for the UE implementation, or some further rules may be specified. For example, the UE may access cells in decreasing quality order, judged by quality at the time of initial access. In another alternative example, the UE may access only the strongest cell(s), judged based on most recent measurements.

According to case (a), where random access succeeds, at 11, T304 can stop. Then, at 12, the UE can send an RRC reconfiguration complete message to the accessed cell. In cases (b) and (c), when the maximum number of access attempts has been reached or T304 has expired, the UE can start a re-establishment procedure.

FIG. 2 is an example flow diagram that can correspond to an embodiment of the method shown in FIG. 1.

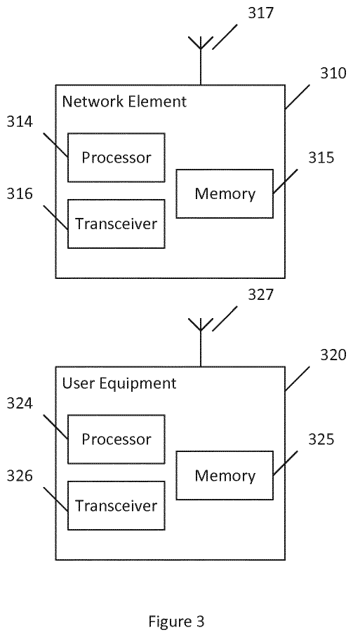

FIG. 3 illustrates a system according to certain embodiments of the invention. It should be understood that each block of the flowchart of FIG. 1 may be implemented by various means or their combinations, such as hardware, software, firmware, one or more processors and/or circuitry. In one embodiment, a system may include several devices, such as, for example, network element 310 and user equipment (UE) or user device 320. The system may include more than one UE 320 and more than one network element 310, although only one of each is shown for the purposes of illustration.

A network element can be an access point, a base station, an eNode B (eNB), or any other network element, such as a next generation Node B (gNB). Each of these devices may include at least one processor or control unit or module, respectively indicated as 314 and 324. At least one memory may be provided in each device, and indicated as 315 and 325, respectively. The memory may include computer program instructions or computer code contained therein, for example for carrying out the embodiments described above. One or more transceiver 316 and 326 may be provided, and each device may also include an antenna, respectively illustrated as 317 and 327. Although only one antenna each is shown, many antennas and multiple antenna elements may be provided to each of the devices. Other configurations of these devices, for example, may be provided. For example, network element 310 and UE 320 may be additionally configured for wired communication, in addition to wireless communication, and in such a case antennas 317 and 327 may illustrate any form of communication hardware, without being limited to merely an antenna.

Transceivers 316 and 326 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 320 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof. The user device or user equipment 320 may be a sensor or smart meter, or other device that may usually be configured for a single location.

In an exemplifying embodiment, an apparatus, such as a node or user device, may include means for carrying out embodiments described above in relation to FIG. 1.

Processors 314 and 324 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof. The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 315 and 325 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 310 and/or UE 320, to perform any of the processes described above (see, for example, FIG. 1). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 3 illustrates a system including a network element 310 and a UE 320, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments of the present invention may have various benefits and/or advantages. For example, certain embodiments may reduce the likelihood of a connection re-establishment, implying a shorter interruption time, and consequently better quality of service (QoS).

More particularly, certain embodiments may have the potential to decrease the likelihood of a re-establishment in situations where the initial access attempt fails but other candidate cells provide sufficient quality for a secondary access. For example, assuming T304 is equal to 200 ms and re-establishment taking 50 ms, the interruption time can be shortened by up to 250 ms, thereby improving the user-perceived QoS.

Situations where the initial access cell disappears in a very short period of time may be rather common in high frequency bands. For example, a passing car may entirely block the connection to a cell in 100 ms or less. Hence, assuming a filtering and TTT of similar (or greater) magnitude, a cell may look good at the access moment, while in reality it may be already blocked, or the actually relevant target may have been blocked before and the “wrong” target may have been prepared. In such cases, it could be beneficial to try other cells before reverting to a more delay consuming contention-based re-establishment procedure.

The coverage of cellular networks may be spotty and higher frequencies may add the likelihood of abruptly blocked signal. Many times, a target cell can be measured to be better than the source, even if the source cell still could handle the UE connectivity. Therefore, using the source cell as one of the candidates may significantly lower the number of re-establishments or radio link failures (RLFs), when RA had failed towards the selected target.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### Listing of Abbreviations

AS Access Stratum

CB Contention Based

CBRA Contention Based Random Access

CF Contention Free

CFRA Contention Free Random Access

CHO Conditional Handover

CSI-RS Channel State Information Reference Signal

HO Handover

HOF Handover Failure

MAC Medium Access Control

MR Measurement Report

NAS Non-access Stratum

RA Random Access

RLF Radio Link Failure

QoS Quality of Service

RAR Random Access Response

RRC Radio Resource Control

RSRP Reference Signal Received Power

RSRQ Reference Signal Received Quality

SINR Signal to Interference and Noise Ratio

SSB Synchronization Signal Block

TTT Time To Trigger

UE User Equipment

1. A method, comprising:
receiving, at a user equipment, an access configuration information element configured to describe a user equipment behavior during an access phase of a conditional handover; and
upon detecting a failed access to the target for which the access condition has triggered, attempting to access a candidate cell among suitable candidate cells that have been previously configured for conditional handover.

2. The method of claim 1, wherein a source cell of the user equipment is one of the suitable candidate cells.

3. The method of claim 1, further comprising:
receiving a pre-configuration of contention free preambles for a source cell; and
selecting the source cell as the candidate cell.

4. The method of claim 1, further comprising:
conditionally attempting further access to another candidate cell after the attempt to access the candidate cell.

5. The method of claim 4, wherein the further access is conditioned on no handover being successful yet.

6. The method of claim 4, wherein the further access is conditioned on no stop condition being satisfied.

7. The method of claim 4, wherein the further access is conditioned on time T304 not having expired.

8. 10. (canceled)

11. The method of claim 1, wherein the access configuration information element comprises a validity criterion parameter.

12. The method of claim 1, wherein the access configuration information element comprises a maximum number of access attempts parameter.

13. The method of claim 1, wherein the access configuration information element comprises a periodicity of access attempts parameter.

14. The method of claim 1, further comprising:
switching to contention based random access resources for a source cell only when the user equipment does not have a conditional handover candidate that can be accessed with contention-free random access resources and the source cell is above a configured quality threshold.

15. The method of claim 1, wherein the attempt to access the candidate cell for which the access condition has triggered is limited according to a configured timer, wherein upon expiration of the timer the user equipment is permitted to attempt to access a further candidate cell which have been previously configured for conditional handover.

16. A method, comprising:
providing, to a user equipment, an access configuration information element configured to describe a user equipment behavior during an access phase of a conditional handover,
wherein the access configuration information is configured to permit a user equipment to, upon detecting a failed access to the target for which the access condition has triggered, attempt to access a candidate cell among suitable candidate cells that have been previously configured for conditional handover.

17. The method of claim 16, wherein a source cell of the user equipment is one of the suitable candidate cells.

18. The method of claim 16, further comprising:
providing a pre-configuration of contention free preambles for a source cell,
wherein the pre-configuration is configured to permit the user equipment to select the source cell as the candidate cell.

19. The method of claim 16, wherein the access configuration information element comprises a validity criterion parameter.

20. The method of claim 16, wherein the access configuration information element comprises a maximum number of access attempts parameter.

21. The method of claim 16, wherein the access configuration information element comprises a periodicity of access attempts parameter.

22. (canceled)

23. An apparatus, comprising:
at least one processor; and
at least one memory including computer program code;
wherein the at least one memory and the computer program code are configured to, with the at least one processor, cause the apparatus at least to perform:
receiving an access configuration information element configured to describe a user equipment behavior during an access phase of a conditional handover; and
upon detecting a failed access to the target for which the access condition has triggered, attempting to access a candidate cell among suitable candidate cells that have been previously configured for conditional handover.

24-25. (canceled)

26. An apparatus, comprising:
at least one processor; and
at least one memory including computer program code;
wherein the at least one memory and the computer program code are configured to, with the at least one processor, cause the apparatus at least to perform the method of claim 16.
